(19) United States
(12) Patent Application Publication
(10) Pub. No.: US 2004/0125692 A1
(43) Pub. Date: Jul. 1, 2004

(54) Clip mixing board with disposable sheets

(75) Inventor: Hanguang Wu, Omaha, NE (US)

Correspondence Address: HANGUANG WU, 5016 South 165th Street, Omaha, NE, 68135, US

(73) Assignee: Hanguang Wu, Omaha, NE (US)

(21) Appl. No.: 10/248,218

(22) Filed: Dec. 28, 2002

(51) Int. Cl. B01F 3/00

(52) U.S. Cl. 366/348

(57) ABSTRACT

A clip mixing board with disposable sheets has been innovatively designed to make filler and compound mixing easier and more efficient, to avoid cleaning the remains left on the board, and to be able to adapt to limited working space due to the flexibility of disposable sheets. This tool helps to maintain a clean work environment, improves the repair quality, and reduces the expenses of labor and materials used to clean a mixing board for each use.

### DETAILED DESCRIPTION

The present invention relates to a tool kit for mixing filler, putty, and compound during the repairs of auto and boat body, furniture surface, and even home wall. The tool kit is composed of a mixing board made of wood or fiber or plastic, disposable sheets made out of paper or film, and a plastic or metal clip mounted on the board to load, hold, and unload disposable sheets.

It is desirable to prevent from cleaning the mixing board after each filler mixing because of labor cost and work environment contamination. Also it is demandable to have a flexible blending sheet to adapt to the limited working space. Using this clip mixing board tool kit, it is not needed to scrape the filler compound remains on the mixing board after each use. A new disposable sheet is used for each mixing. The clean and smooth surface of a new sheet guarantees the mixing quality and makes the mixing operation easy and efficient. When removed from the mixing board, the flexibility of the disposable sheet allows it to be twisted into different shapes and applied to situations where only limited space is available.

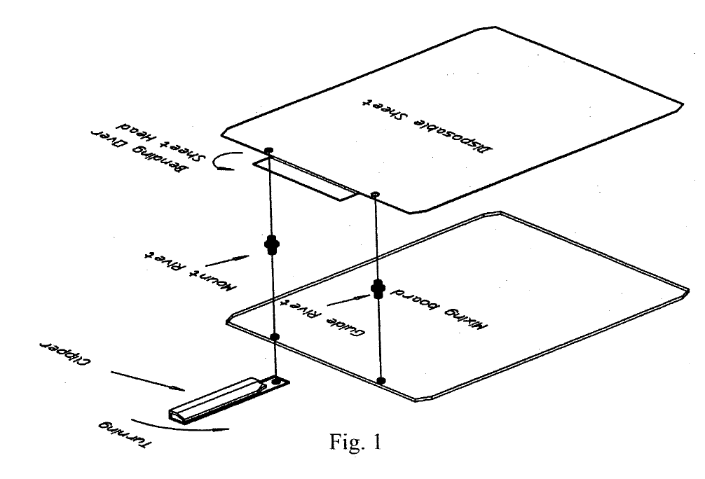

FIG. 1 is a layout of the clip mixing board with disposable sheets. The drawing on top is the disposable sheet. The sheet has an overhead tab used to fold over the mixing-board and two holes to easily align itself with the mixing-board and clip. Below the sheet are two collar rivets. One mounts the clip to the board and acts as a pivot, allowing it to turn freely. Together both rivets serve as guide pegs to position the disposable sheet. Further down on FIG. 1 is the unbendable mixing board. There are two holes on it too. One is designed to mount the board and clip together; the other is to retain a guide peg. The bottom drawing is a U clip. The clip holds the disposable sheet firmly when it is turned to the closed position. The new or used sheets can be easily installed or removed when the clip is open.

The present invention provides a low cost and easy-to-use tool kit for mixing filler and other compounds.

1. a method of mixing filler, putty, and compounds by using the clip mixing board with disposable sheets:

2. A method, according to claim 1, of making clip mixing board out of plastic or paper or fiber.

3. A method, according to claim 1, of making disposable sheets out of paper or film.
